(19) United States
(12) Patent Application Publication
(10) Pub. No.: US 2011/0317530 A1
(43) Pub. Date: Dec. 29, 2011

(54) PLAYBACK DEVICE, PLAYBACK METHOD AND PROGRAM

(75) Inventor: Takahiro TAMURA, Tokyo (JP)

(73) Assignee: Sony Corporation, Tokyo (JP)

(21) Appl. No.: 13/160,834

(22) Filed: Jun. 15, 2011

(30) Foreign Application Priority Data
Jun. 29, 2010 (JP) 2010-147634

(51) Int. Cl. G11B 20/10

(52) U.S. Cl. 369/47.5; G9B/20.009

(57) ABSTRACT

A playback device of present invention includes a power switching portion that, when the necessity of switching of the reproducing condition is detected, switches the reproducing power to a minimum power which does not damage the data recorded on the multi-layer recording medium and with which the address of the reproducing target data can be read out, and when it is confirmed after the switching of the reproducing condition that the address read out with the minimum power matches the address of the reproducing target data, switches the reproducing power to the optimum power that corresponds to the reproducing condition after the switching, based on the power setting information.

### BACKGROUND OF THE INVENTION

1. Field of the Invention

The present invention relates to a playback device, a playback method and a program.

2. Description of the Related Art

In recent years, there is a demand for an increase in capacity of optical discs, such as a DVD, an HD-DVD, a blue-ray disc and the like. Particularly, in blue-ray discs, a two-layer disc having a storage capacity of 50 GB has been achieved. However, actually, the demand for the increase in capacity has not been satisfied completely. Therefore, in order to further promote the increase in capacity, practical use of multi-layer discs, such as a three-layer disc and a four-layer disc, is now being promoted (refer to Japanese Patent Application Publication No. JP-A-2009-140580, for example).

### SUMMARY OF THE INVENTION

In a multi-layer disc standard for blue-ray discs, a laser beam of reproducing power that differs depending on a recording layer is recommended to be used to reproduce data. A relatively large gap in the reproducing power is set between recording layers. Therefore, for example, if a reproducing target shifts from a recording layer on which a high reproducing power should be used for reproduction to a recording layer on which a low reproducing power should be used for reproduction, there is a case in which a laser beam of a high reproducing power is temporarily irradiated onto the recording layer on which a low reproducing power should be used for reproduction. In this case, the data recorded on the recording layer may be damaged (deleted or changed) in response to a gap in the reproducing power between the recording layers.

In light of the foregoing, the present invention provides a playback device, a playback method and a program that are capable of safely reproducing data in a multi-layer recording medium, even with a reproducing power that differs depending on a recording layer.

According to an embodiment of the present invention, there is provided a playback device includes a storage portion that stores power setting information that sets an optimum power corresponding to a reproducing condition that indicates a reproducing target recording layer, a detection portion that detects a necessity of switching of the reproducing condition, a reproducing condition switching portion that switches the reproducing condition in accordance with the necessity of switching of the reproducing condition, a reading portion that reads out data recorded on a multi-layer recording medium and an address of the data, a confirmation portion that confirms whether the read out address matches an address of reproducing target data, a power switching portion that switches the reproducing power in response to the switching of the reproducing condition, and a power switching portion that, when the necessity of switching of the reproducing condition is detected, switches the reproducing power to a minimum power which does not damage the data recorded on the multi-layer recording medium and with which the address of the reproducing target data can be read out, and when it is confirmed after the switching of the reproducing condition that the address read out with the minimum power matches the address of the reproducing target data, switches the reproducing power to the optimum power that corresponds to the reproducing condition after the switching, based on the power setting information.

In this configuration, the power setting information sets the optimum power corresponding to the reproducing condition that indicates the reproducing target recording layer and a rotation speed of a reproducing target track.

In this configuration, the minimum power is set as a minimum power among powers set as the power setting information.

In this configuration, the minimum power is set as a minimum power among powers set in accordance with the reproducing condition included in a switching range of the reproducing condition.

In this configuration, the multi-layer recording medium has at least three recording layers, and it is recommended that the reproducing power is different between at least one layer and another layer adjacent to the one layer.

According to another embodiment of the present invention, there is provided a playback method, includes the steps of detecting a necessity of switching of a reproducing condition that indicates a reproducing target recording layer, switching, when the necessity of the switching is detected, a reproducing power to a minimum power which does not damage data recorded on a multi-layer recording medium and with which an address of reproducing target data can be read out, reading out the address of the reproducing target data with the minimum power, after switching the reproducing condition, confirming whether the read out address matches the address of the reproducing target data, switching, when it is confirmed that the addresses match with each other, based on power setting information that sets an optimum power that corresponds to the reproducing condition, the reproducing power to the optimum power that corresponds to the reproducing condition after the switching, and reading out the reproducing target data with the optimum power.

In this configuration, the reproducing condition indicates the reproducing target recording layer and a rotation speed of a reproducing target track.

In this configuration, the playback method further includes the step of, confirming, after the necessity of the switching is detected, whether the optimum power corresponding to the reproducing condition before the switching is different from the optimum power corresponding to the reproducing condition after the switching, based on the power setting information. Only when the optimum powers are different from each other, the subsequent processing that includes switching the reproducing power to the minimum power is performed.

According to another embodiment of the present invention, a program that comprises instructions that command a computer to perform a playback method including the steps of detecting a necessity of switching of a reproducing condition that indicates a reproducing target recording layer, switching, when the necessity of the switching is detected, a reproducing power to a minimum power which does not damage data recorded on a multi-layer recording medium and with which an address of reproducing target data can be read out, reading out the address of the reproducing target data with the minimum power, after switching the reproducing condition, confirming whether the read out address matches the address of the reproducing target data, switching, when it is confirmed that the addresses match with each other, based on power setting information that sets an optimum power that corresponds to the reproducing condition, the reproducing power to the optimum power that corresponds to the reproducing condition after the switching, and reading out the reproducing target data with the optimum power.

According to the present invention described above, it is possible to provide a playback device, a playback method and a program that are capable of safely reproducing data in a multi-layer recording medium, even with a reproducing power that differs depending on a recording layer.

### BRIEF DESCRIPTION OF THE DRAWINGS

FIG. 1 is a diagram showing an overview of a playback method according to an embodiment of the present invention;

FIG. 2 is a block diagram showing a structure of a disc drive device according to the embodiment of the present invention;

FIG. 3 is a diagram showing a pickup structure of the disc drive device;

FIG. 4 is a diagram showing a layer structure of a multi-layer disc;

FIG. 5 is a flowchart showing operations of the disc drive device; and

FIG. 6 is a diagram showing power setting information for a reproducing condition.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. OVERVIEW OF PLAYBACK METHOD

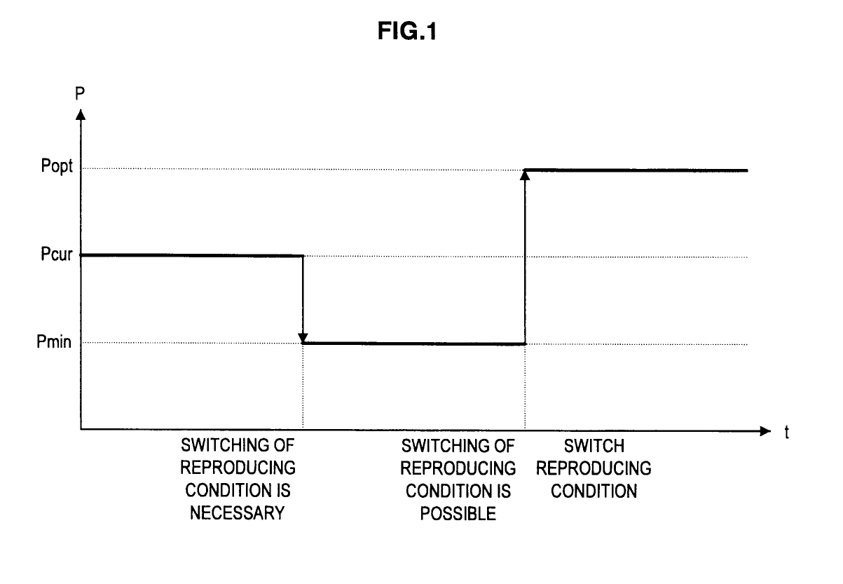

First, an overview of a playback method according to an embodiment of the present invention will be described with reference to FIG. 1. The playback method according to the embodiment of the present invention allows safe reproduction of data in a multi-layer disc D, even with a reproducing power P (P being a collective term for reproducing powers) that differs depending on a recording layer L (L being a collective term for recording layers).

As shown in FIG. 1, in the playback method according to the embodiment of the present invention, power setting information T is set in advance. The power setting information T sets an optimum reproducing power P that corresponds to a reproducing condition indicating the recording layer L that becomes a reproducing target. The power setting information T is set such that, when a pickup 13 irradiates a laser beam, the reproducing power of the uppermost recording layer L (the closest layer to the pickup 13, which will be described later) is lowest and the reproducing power of the other layers is the same.

In the playback method, first, it is detected whether the reproducing condition needs to be switched. More specifically, it is detected whether the recoding layer L that becomes a reproducing target needs to be switched. When the necessity of the switching is detected, a reproducing power Pcur before the switching is switched to a minimum power Pmin. It should be noted herein that the minimum power Pmin is set as a power which does not damage data recorded on the multi-layer disc D and with which an address of reproducing target data can be read out.

Next, after the reproducing condition has been switched, the address of the reproducing target data is read out using the minimum power Pmin, and it is confirmed whether the address that has actually been read out matches the address of the reproducing target data. When it is confirmed that the addresses match with each other, based on the power setting information T, the reproducing power P is switched to an optimum power Popt that suits the reproducing condition after the switching. Then, the reproducing target data is read out using the optimum power Popt.

More specifically, when the reproducing condition is switched, the reproducing power Pcur before the switching is temporarily switched to the minimum power Pmin. Then, only after it has been confirmed that the reproducing power P is able to be appropriately switched, the reproducing condition is switched and the reproducing power P is switched to the optimum power Popt. Therefore, until it is confirmed that the reproducing power P is able to be appropriately switched, a laser beam of the minimum power Pmin, which does not damage the data recorded on the multi-layer disc D and with which the address of the reproducing target data can be read out, is irradiated onto a recording surface.

Therefore, for example, even when the reproducing target shifts from the recording layer L, on which a high level of the reproducing power P should be used for reproduction, to the recording layer L, on which a low level of the reproducing power P should be used for reproduction, a laser beam of the high level of the reproducing power P is not irradiated onto the recording layer L on which the low level of the reproducing power P should be used for reproduction. Therefore, even when a gap in the reproducing power P is significant between the recording layers L, the data recorded on each of the recording layers L is not damaged (deleted or changed), and it is possible to safely reproduce data even when the reproducing power P is different depending on each of the recording layers L.

Further, in order to reliably reproduce data even with a different rotation speed V (V being a collective term for rotation speeds), as well as to safely reproduce data even with the reproducing power P that differs depending on each of the recording layers L, the optimum reproducing power P that corresponds to a reproducing condition composed of the recording layer L that becomes a reproducing target and of the rotation speed V of a reproducing track may be set as the power setting information T.

### 2. STRUCTURE OF DISC DRIVE DEVICE 1

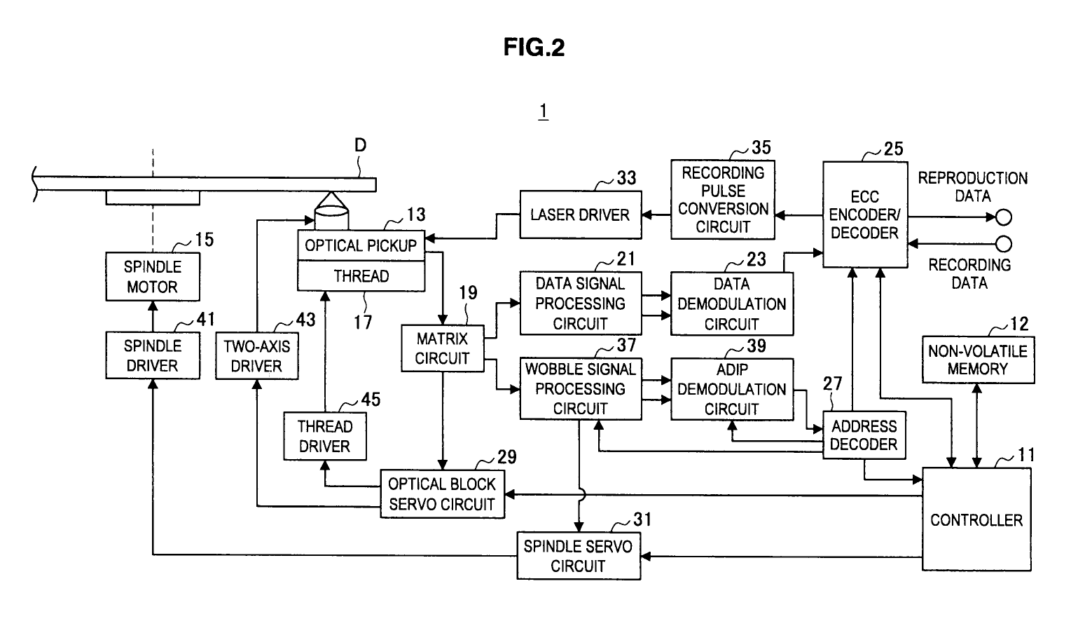

Next, a structure of a disc drive device 1 according to the embodiment of the present invention will be described with reference to FIG. 2 to FIG. 4.

As shown in FIG. 2, the disc drive device 1 includes a controller 11, the pickup 13, a spindle motor 15, a thread 17, a matrix circuit 19, a data signal processing circuit 21, a data demodulation circuit 23, an ECC encoder/decoder 25, an address decoder 27, an optical block servo circuit 29, a spindle servo circuit 31, a laser driver 33, a recording pulse conversion circuit 35, a wobble signal processing circuit 37, an ADIP demodulation circuit 39, a spindle driver 41, a two-axis driver 43 and a thread driver 45.

The multi-layer disc D is rotationally driven at a constant linear velocity (CLU) by the spindle motor 15 when data is recorded/reproduced. When the data is recorded, the pickup 13 irradiates a laser beam onto the recording layer L of the multi-layer disc D and records the data by forming pit marks. When the data is reproduced, the pickup 13 reproduces the data by reading the pit marks. Further, the pickup 13 reads out address information (address in pregroove (ADIP) information) that is embedded as a wobbling groove on the multi-layer disc D.

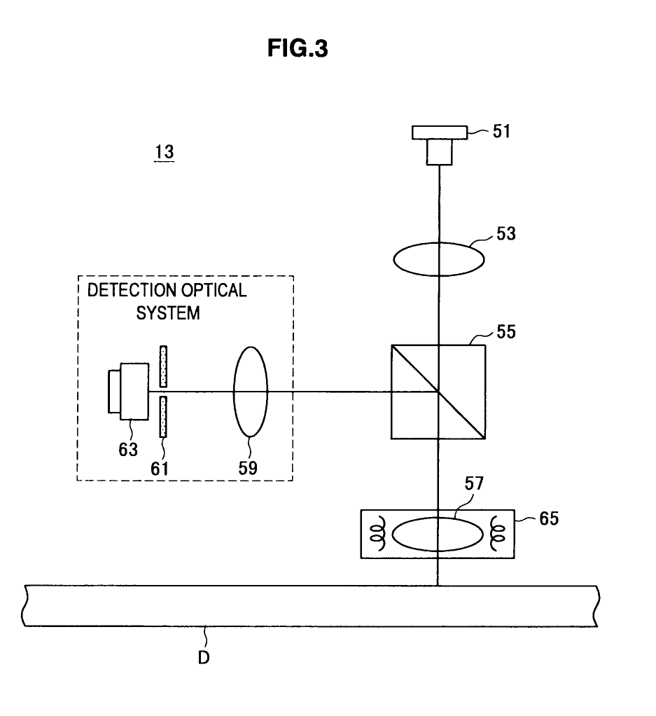

The pickup 13 includes a laser light source 51, a photo detector 63 that detects reflected light, an objective lens 57 serving as an output end of a laser beam, and an optical system that irradiates the laser beam onto the recording surface via the objective lens 57 and directs the reflected light from the recording surface to the photo detector 63 (refer to FIG. 3). In the pickup 13, the objective lens 57 is movably held in a tracking direction and a focus direction by a two-axis actuator 65. The pickup 13 is movably held in a disc radial direction by the thread 17. The laser light source 51 of the pickup 13 is driven to emit light by a drive signal from the laser driver 33. The photo detector 63 detects reflected light information from the multi-layer disc D and supplies the reflected light information to the matrix circuit 19 as an electrical signal corresponding to a received light amount.

The matrix circuit 19 includes a current-voltage conversion circuit corresponding to currents output from a plurality of light receiving elements of the photo detector 63, a matrix calculation/amplification circuit and the like, and generates necessary signals by matrix calculation processing. The matrix circuit 19 generates, for example, a high-frequency signal (RF signal) corresponding to reproduction data, a focus error signal for servo control, a tracking error signal, and a push-pull signal to detect wobbling. The RF signal (reproduction data signal) is supplied to the data signal processing circuit 21, and the focus error signal and the tracking error signal are supplied to the optical block servo circuit 29. The push-pull signal is supplied to the wobble signal processing circuit 37.

The data signal processing circuit 21 performs, on the RF signal, binary processing and reproduction clock generation processing by phase locked loop (PLL) processing, and supplies the read out data to the data demodulation circuit 23. At the time of data reproduction, the data demodulation circuit 23 performs demodulation processing of a run length limited code based on a reproduction clock. The decoded data is supplied to the ECC encoder/decoder 25.

The ECC encoder/decoder 25 performs ECC encoding processing that adds an error correction code at the time of data recording, and also performs ECC decoding processing that corrects an error based on the error correction code at the time of data reproduction. At the time of data reproduction, the ECC encoder/decoder 25 loads the data demodulated by the data demodulation circuit 23 into an internal memory. Then, the ECC encoder/decoder 25 performs error detection/correction processing and deinterleave processing etc., and acquires reproduction data. In the ECC encoder/decoder 25, the decoded data is read out based on a command from the controller 11 and is output as the reproduction data.

The wobble signal processing circuit 37 digitalizes the push-pull signal output from the matrix circuit 19 and converts it into wobble data. Then, the wobble signal processing circuit 37 generates a clock in synchronization with the push-pull signal by performing the PLL processing. The ADIP demodulation circuit 39 demodulates the wobble data to a data stream forming an ADIP address, and supplies the data stream to the address decoder 27. The address decoder 27 acquires an address value by decoding the supplied data, and supplies the address value to the controller 11.

At the time of data recording, the recorded data to be supplied to the disc drive device 1 is buffered in a memory of the ECC encoder/decoder 25. In this case, as encoding processing of the buffered recorded data, the ECC encoder decoder 25 performs addition of an error correction code, interleaving, and addition of a sub-code etc. The recording pulse conversion circuit 35 modulates the ECC encoded data using a predetermined run length limited code. Note that a clock generated from a wobble signal is used as an encode clock that is used as a reference clock when the encoding processing is performed.

As recording/reproduction compensation processing, the laser driver 33 performs adjustment of an optimum recording/reproducing power with respect to characteristics of the recording layers L, a spot shape of a laser beam and a recording/reproducing linear velocity, and adjustment of a laser drive pulse waveform. Then, the laser driver 33 supplies a laser drive pulse, on which the recording compensation processing has been performed, to the laser light source 51 of the pickup 13 to perform light emission drive, and causes pit marks in accordance with the recorded data to be formed on the recording surface of the multi-layer disc D. In a similar manner, the laser driver 33 supplies a laser drive pulse, on which the reproduction compensation processing has been performed, to the laser light source 51 of the pickup 13 to perform light emission drive, and causes the pit marks in accordance with the recorded data to be read from the recording surface of the multi-layer disc D.

The optical block servo circuit 29 outputs a search drive signal to draw a focus or a jump drive signal to move the recording layer L with respect to the multi-layer disc D, in response to a focus search command or a focus jump command from the controller 11. Thus, the optical block servo circuit 29 causes a focus search operation or a focus jump operation to be performed. Further, the optical block servo circuit 29 turns off a tracking servo loop and outputs a tracking drive signal to jump/seek, in response to a track jump command or a seek command from the controller 11. Thus, the optical block servo circuit 29 causes a track jump operation or a seek operation to be performed.

The optical block servo circuit 29 generates a thread drive signal based on a thread signal that is obtained as a low-frequency component of the tracking error signal and on access execution control and the like from the controller 11, and drives the thread 17 using the thread driver 45. The thread 17 has a mechanism that is formed by a main shaft that holds the pickup 13, a thread motor, a transmission gear and the like. By driving the thread motor in response to the thread drive signal, a required slide movement of the pickup 13 is performed.

The spindle servo circuit 31 controls the spindle motor 15 to rotate at a constant linear velocity (CLV). The spindle servo circuit 31 acquires a clock that is generated by performing the PLL processing on a wobble signal, as rotation speed information of the spindle motor 15, and compares it with predetermined CLV reference speed information, thereby generating a spindle error signal. At the time of data reproduction, a reproduction clock (a clock used as a reference for decoding processing) that is generated by the PLL processing of the data signal processing circuit 21 is used as current rotation speed information of the spindle motor 15. Therefore, the spindle error signal is generated by comparing the reproduction clock with the predetermined CLV reference speed information.

Then, the spindle servo circuit 31 outputs a spindle drive signal that is generated in response to the spindle error signal, and causes the spindle driver 41 to perform the CLV rotation of the spindle motor 15. Further, the spindle servo circuit 31 causes a spindle drive signal to be generated in response to a spindle kick/brake control signal from the controller 11, and also causes operations such as activation, stop, acceleration, deceleration and the like of the spindle motor 15 to be performed.

The above-described operations of a servo system and a recording/reproducing system are controlled by the controller 11 formed as a microcomputer. The controller 11 is additionally provided with a non-volatile memory 12 to store the power setting information T, which will be described later. The controller 11 performs calculation processing and control necessary for operations of the disc drive device 1, through a program executed on a processor.

Here, the controller 11 functions as a detection portion and a confirmation portion. The non-volatile memory 12 functions as a storage portion. The optical block servo circuit 29 and the spindle servo circuit 31 each function as a reproducing condition switching portion under control of the controller 11. The optical pickup 13, along with a data reproducing processing system, functions as a reading portion under control of the controller 11. The laser driver 33 functions as a power switching portion under control of the controller 11.

As shown in FIG. 3, in the pickup 13, the laser beam from the laser source 51 reaches a collimate lens 53 and a beam splitter 55, and is focused on the recording layer L of the multi-layer disc D by the objective lens 57. The objective lens 57 is held by the two-axis actuator 65 such that it can move in a focus direction and a tracking direction, and the objective lens 57 is controlled by the above-described servo operations. The reflected light from the multi-layer disc D is directed to a detection optical system via the objective lens 57 and the beam splitter 55, and the reflected light of a desired one of the recording layers L is detected by the photo detector 63 by means of a lens system 59 and a pin hole 61. The photo detector 63 generates a signal that corresponds to the detected reflected light, and supplies the generated signal to the matrix circuit 19 in order to generate a reproduction data signal, a focus error signal, a tracking error signal and the like.

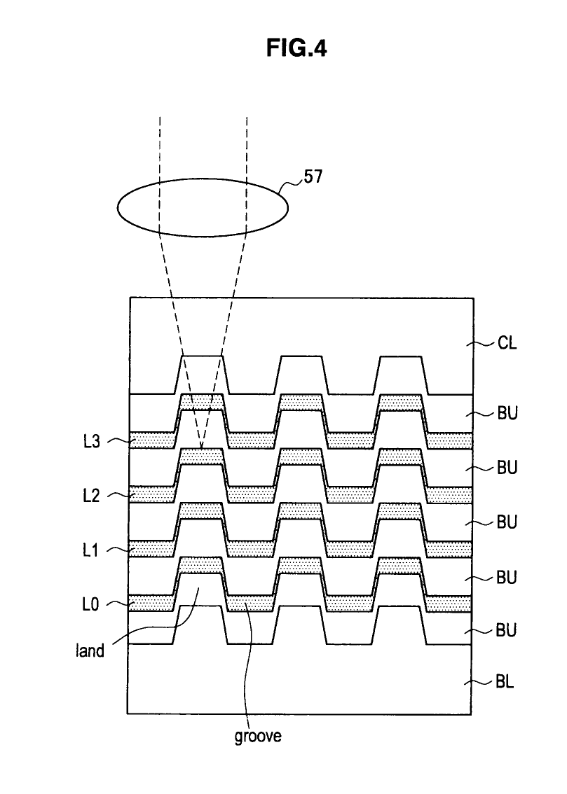

FIG. 4 shows a structure of the multi-layer disc D that is loaded in the disc drive device 1. As shown in FIG. 4, in the multi-layer disc D, four recording layers L0 to L3 are formed between a cover layer CL located on a laser beam incident side and a base layer BL, via each of buffer layers BU. Note that the recording layers L may be formed in three layers or five or more layers. Each of the recording layers L is formed to have a groove/land structure, and one of the groove and the land or both of them become recording tracks. Each of the recording layers L has a predetermined reflectivity and/or absorptivity with respect to a wavelength (390 nm to 410 nm) of the laser beam of the laser light source 51.

After passing through the collimate lens 53, the laser beam from the laser light source 51 is reflected by the beam splitter 55, directed by the objective lens 57, and irradiated onto the recording layer L of the multi-layer disc D. Here, since each of the recording layers L has a predetermined reflectivity with respect to the wavelength of 390 nm to 410 nm, the reflected light can be obtained from each of the recording layers L of the multi-layer disc D.

The reflected light from each of the recording layers L reaches the detection optical system, again via the objective lens 57 and the beam splitter 55, and is detected as an electrical signal by the photo detector 63. Therefore, a desired one of the recording layers L can be selected by the detection optical system and it is possible to acquire a reproduction data signal with respect to the desired one of the recording layers L.

In a similar manner, a focus error signal and a tracking error signal are acquired from the reflected light from the recording layers L. This is because, since a recording track is formed as a land or a groove on each of the recording layers L, focus information and tracking information are included in the reflected light from the recording layers L detected by the photo detector 63. Therefore, by acquiring each error signal from the reflected light, the laser beam from the laser light source 51 can be focused on a desired track of a desired one of the recording layers L.

### 3. OPERATIONS OF DISC DRIVE DEVICE 1

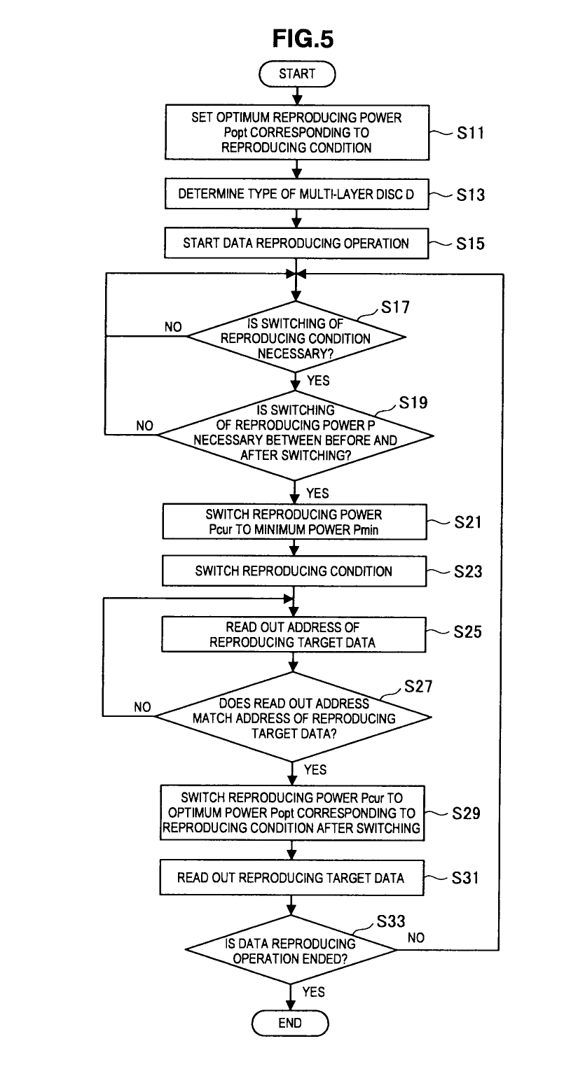

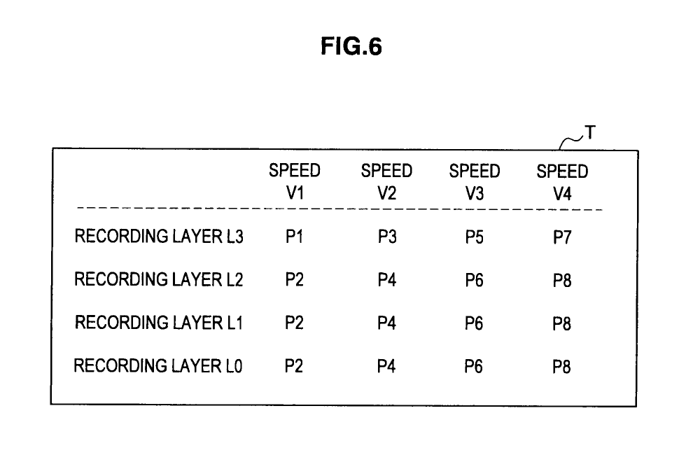

Hereinafter, operations of the disc drive device 1 will be described with reference to FIG. 5 and FIG. 6. Hereinafter, a case will be described in which data is safely reproduced even with the reproducing power P that differs depending on each of the recording layers L and also in which the data is reliably reproduced even with a different rotation speed V.

As shown in FIG. 5, the power setting information T that sets the optimum reproducing power P that corresponds to the reproducing condition is set in advance in the disc drive device 1 (step S11). The power setting information T is set corresponding to the reproducing condition that indicates the recording layer L that becomes a reproducing target and to the rotation speed V (linear velocity) of a reproducing target track. The power setting information T is stored, for example, in the non-volatile memory 12 attached to the controller 11.

FIG. 6 shows the power setting information T to reproduce the multi-layer disc D including the four recording layers L0 to L3, at four levels of the rotation speed V, namely, at speeds V1, V2, V3 and V4. Although FIG. 6 shows only one pattern of the power setting information T, the power setting information T is set for each type of the multi-layer disc D that can be reproduced by the disc drive device 1. It should be noted herein that the speeds V1 to V4 have a relationship of V1<V2<V3<V4.

Note that the power setting information T may set a reproduction speed of the multi-layer disc D, instead of the rotation speed V of the track. In this case, the rotation speed V of the track may be calculated based on the reproduction speed of the multi-layer disc D and the position of the reproducing target track.

In the example shown in FIG. 6, when the recording layers L0 to L2 or the recording layer L3 is reproduced at the speed V1, the reproducing power P is set to P2 or P1. More specifically, when the rotation speed V is the same, a gap in the reproducing power P is set between the recording layers L0 to L2 and the recording layer L3, namely, between the recording layer L2 and the recording layer L3 adjacent to the recording layer L2. In a similar manner, the reproducing power P is set to P3 or P4 at the speed V2, the reproducing power P is set to P5 or P6 at the speed V3, and the reproducing power P is set to P7 or P8 at the speed V4. It should be noted herein that the reproducing powers P1 to P8 have a relationship of P1<P2<P3<P4<P5<P6<P7<P8.

Note that the classification of the reproducing power P shown in FIG. 6 is just an example, and the reproducing power P may be classified based on the recording layers L other than the four layers and the rotation speed V of levels other than the four levels. The gap in the reproducing power P may be formed other than between the recording layers L0 to L2 and the recording layer L3. The magnitude relationship between the reproducing powers P1 to P8 is just an example, and it may be set to P2=P3 or P2>P3, for example.

When the multi-layer disc D is loaded in the disc drive device 1, the type of the multi-layer disc D is determined (step S13). The type of the multi-layer disc D is determined, for example, through a disc type determination operation based on an estimation result obtained by physical information, such as the reflectivity of the multi-layer disc D and a count of the number of the recording layers L, or based on logic information obtained by disc information that is read out from the multi-layer disc D. When there are a plurality of types of the multi-layer disc D that can be reproduced by the disc drive device 1, the power setting information T corresponding to the multi-layer disc D loaded in the disc drive device 1 is selected based on a determination result.

When the type of the multi-layer disc D is determined, a data reproducing operation is started (step S15). The controller 11 specifies a target address and a target speed when reproduction is started, and commands the spindle servo circuit 31 and the optical block servo circuit 29 to start reproduction. The spindle servo circuit 31 controls the CLV rotation of the spindle motor 15 in order to reach the target speed. The optical block servo circuit 29 controls operations of the thread 17 and the pickup 13 in order to access the target address.

At this time, the controller 11 identifies the reproducing condition (the recording layer L that becomes a reproducing target and the rotation speed V of a reproducing target track) based on the target address and the target speed, and determines the optimum power Popt that corresponds to the reproducing condition based on the power setting information T. The controller 11 commands the laser driver 33 to use the determined optimum power Popt, and the laser driver 33 drives the laser light source 51 to irradiate a laser beam with the optimum power Popt. The pickup 13 irradiates the laser beam from the laser light source 51 onto the recording layer L with the optimum power Popt, detects the reflected light from the recording layer L, and supplies the detected reflected light to the matrix circuit 19.

In the matrix circuit 19, an RF signal, a focus error signal, a tracking error signal and a push-pull signal are generated. In a reproduction processing system that includes the data signal processing circuit 21, the data demodulation circuit 23 and the ECC encoder/decoder 25, the reproduction data is generated from the RF signal and output to a higher-level device (not shown in the drawings) or the like. In the optical block servo circuit 29, optical block servo processing is performed based on the focus error signal and the tracking error signal. In an address processing system that includes the wobble signal processing circuit 37, the ADIP demodulation circuit 39 and the address decoder 27, a current address is acquired from the push-pull signal and supplied to the controller 11.

When the data reproducing operation is started, it is determined whether the reproducing condition needs to be switched (step S17). The controller 11 determines the necessity of the switching as appropriate during the data reproducing operation. The necessity of the switching occurs in response to a change in a reproduction address or a change in the reproduction speed. The switching of the reproducing condition becomes necessary, for example, in the following cases:

(1) A case in which it is necessary to change the recording layer L that becomes a reproducing target, due to a change in the reproduction address;

(2) A case in which the zone of a reproducing target track is changed due to a change in the reproduction address, and it is necessary to change the rotation speed V (linear velocity) of the reproducing target track (the rotation speed V (linear velocity) increases as the track location is nearer to the inner periphery of the multi-layer disc D); and

(3) A case in which it is necessary to change the rotation speed V of the reproducing target track due to a change in the reproduction speed.

The controller 11 compares the current address supplied from the address decoder 27 with the target address that becomes a reproducing target after the switching. Thus, it can determine whether the reproduction address has been changed. Further, the controller 11 compares a relationship between the current rotation speed V and the current address with a relationship between the target rotation speed V of the track that becomes a reproducing target after the switching and the target address. Thus, it can determine whether the reproduction speed has been changed.

As the cases (1) and (2), the following case is conceivable in which the reproduction address is automatically changed due to a switching operation of the reproducing track by a user, or due to continuation of the data reproducing operation. As the case (3), the following case is conceivable in which the reproduction speed is changed in response to a switching operation of a double speed mode by the user, or the like. Note that the cases (1), (2) and (3) may occur individually or in combination.

When the necessity of the switching is detected, it is determined whether it is necessary to switch the reproducing power P between before and after the switching (step S19). Based on the power setting information T, the controller 11 compares the optimum power Popt corresponding to the reproducing condition before the switching with the optimum power Popt corresponding to the reproducing condition after the switching. Thus, the controller 11 determines whether it is necessary to switch the reproducing power P between before and after the switching. Note that, when the necessity of the switching is not detected, the processing returns to step S17.

In the example shown in FIG. 6, when the reproducing condition is switched from a condition “the recording layer L0 and the speed V1” to a condition “the recording layer L3 and the speed V1”, for example, switching from the reproducing power P2 to the reproducing power P1 is necessary. In a similar manner, when the reproducing condition is switched from the condition “the recording layer L0 and the speed V1” to a condition “the recording layer L0 and the speed V2”, switching from the reproducing power P2 to the reproducing power P4 is necessary. Further, when the reproducing condition is switched from the condition “the recording layer L1 and the speed V1” to a condition “the recording layer L1 and the speed V3”, switching from the reproducing power P2 to the reproducing power P6 is necessary.

When it is determined that the switching of the reproducing power P is necessary, the reproducing power P is switched to the minimum power Pmin (step S21). A setting value of the minimum power Pmin is stored in the non-volatile memory 12 or the like together with the power setting information T. The controller 11 commands the laser driver 33 to use the minimum power Pmin, and the laser driver 33 drives the laser light source 51 to irradiate a laser beam with the minimum power Pmin. Note that, when the switching of the reproducing power P is not necessary, the processing returns to step S17.

It should be noted herein that the minimum power Pmin is set as a power which does not damage the data recorded on the recording layers L0 to L3 and with which the address of the reproducing target data can be read out. The minimum power Pmin may be a minimum power (for example, the reproducing power P1) that is specified as the power setting information T, or it may be a power that is not specified as the power setting information T. Note that, even when the switching of the reproducing power P is not necessary, the reproducing power P may be switched to the minimum Power Pmin. Thus, even when the reproducing condition is erroneously switched to a reproducing condition that requires switching of the reproducing power P, instead of being switched to an original reproducing condition, it is possible to avoid damage to the data recorded on the multi-layer disc D.

When the reproducing power P is switched to the minimum power Pmin, the reproducing condition is switched (step S23). The controller 11 specifies the target address and the target speed, and commands the spindle servo circuit 31 and the optical block servo circuit 29 to continue reproduction. In order to achieve the target speed after the switching, the spindle servo circuit 31 controls the CLU rotation of the spindle motor 15, as appropriate. Meanwhile, in order to access the target address after the switching, the optical block servo circuit 29 controls the operations of the optical thread 17 and the pickup 13, as appropriate.

When the reproducing condition is switched, the address of the reproducing target data is read out with the minimum power Pmin (step S25). The pickup 13 irradiates a laser beam from the laser light source 51 onto the recording layer L with the minimum power Pmin, detects the reflected light from the recording layer L, and supplies the reflected light to the matrix circuit 19. In the matrix circuit 19, a focus error signal, a tracking error signal and a push-pull signal are generated. In the address processing system, a current address is acquired from the push-pull signal and the current address is supplied to the controller 11.

After the reproducing condition has been switched, the address is read out with the minimum power Pmin. Therefore, even when the reproducing condition is switched to a reproducing condition that requires the reproducing power P lower than that of the original reproducing condition, the data recorded on the recording layer L is not damaged by the irradiation of the laser beam when the address is read out.

When the address of the reproducing target data is read out, it is determined whether the read out address matches the address of the reproducing target data (step S27). The controller 11 determines whether the current address matches the target address. When it is determined that the addresses match with each other, it is confirmed that the target address has been accessed and that the rotation speed V of the reproducing target track has reached the target speed. Note that, if the address itself is not read out or if it is not confirmed that the addresses match with each other, the processing returns to step S25 and error response processing is performed in which a reading operation is repeated, for example.

When it is confirmed that the addresses match with each other, based on the power setting information T, the reproducing power P is switched to the optimum power Popt that corresponds to the reproducing condition after the switching (step S29). The controller 11 identifies the reproducing condition (the recording layer L and the rotation speed V) from the target address and the target speed, and determines, based on the power setting information T, the optimum power Popt that corresponds to the reproducing condition. The controller 11 commands the laser driver 33 to use the determined optimum power Popt, and the laser driver 33 drives the laser light source 51 to irradiate a laser beam with the optimum power Popt.

When the reproducing power P is switched to the optimum power Popt, the reproducing target data is read out with the optimum power Popt (step S31). The pickup 13 irradiates a laser beam from the laser light source 51 onto the recording layer L with the optimum power Popt, detects the reflected light from the recording layer L, and supplies the reflected light to the matrix circuit 19.

In the matrix circuit 19, an RF signal, a focus error signal, a tracking error signal and a push-pull signal are generated. In the reproduction processing system, the reproduction data is generated from the RF signal and output to a higher-level device or the like. In the optical block servo circuit 29, the optical block servo processing is performed based on the focus error signal and the tracking error signal. In the address processing system, a current address is acquired from the push-pull signal and supplied to the controller 11. Then, the processing from step S17 to step S31 is repeated until the reproducing operation is ended by a user operation or a device determination (step S33).

### 4. CONCLUSION

As described above, with the playback method according to the embodiment of the present invention, when the reproducing condition is switched, the reproducing power Pcur before the switching is temporarily switched to the minimum power Pmin. Then, only after it has been confirmed that the reproducing power P is able to be appropriately switched, the reproducing condition is switched and the reproducing power P is switched to the optimum power Popt. Therefore, until it is confirmed that the reproducing power P is able to be appropriately switched, a laser beam of the minimum power Pmin, which does not damage the data recorded on the multi-layer disc D and with which the address of the reproducing target data can be read out, is irradiated onto the recording surface.

Therefore, for example, even when the reproducing target shifts from the recording layer L on which a high level of the reproducing power P should be used for reproduction to the recording layer L on which a low level of the reproducing power P should be used for reproduction, a laser beam of the high level of the reproducing power P is not irradiated onto the recording layer L on which the low level of the reproducing power P should be used for reproduction. Therefore, even when a gap in the reproducing power P is significant between the recording layers L, the data recorded on each of the recording layers L is not damaged (deleted or changed), and it is possible to safely reproduce the data even when the reproducing power P is different depending on each of the recording layers L. Further, by setting the optimum reproducing power P corresponding to the rotation speed V (linear velocity) of the reproducing track, it is possible to reliably reproduce the data even when the rotation speed V is different.

The exemplary embodiment of the present invention is described in detail above with reference to the accompanying drawings. However, the present invention is not limited to the examples described above. It should be understood by those skilled in the art that various modifications, combinations, sub-combinations and alterations may occur depending on design requirements and other factors insofar as they are within the scope of the appended claims or the equivalents thereof.

For example, in the above description, a case is described in which the minimum power Pmin is set as the reproducing power P which does not damage the data recorded on the multi-layer disc D and with which the address of the reproducing target data can be read out. However, the minimum power Pmin may be set as the minimum reproducing power P, among the reproducing powers P set in accordance with the reproducing condition(s) included in a reproducing condition switching range. Thus, it is possible to reduce a switching range of the reproducing power P while suppressing data damage.

For example, a case will be described in which the reproducing condition is switched from the condition “the recording layer L1 and the speed V3” to a condition “the recording layer L2 and the speed V4”. In this case, it is assumed that a switching error between the recording layers L occurs at the recording layer L1 level, and an error in the rotation speed V occurs at the speed V1 level, and that switching is performed within a range of the recording layer L0 to the recording layer L2 and the speed V2 to the speed V4. Then, the minimum power Pmin among the reproducing powers P set in accordance with the reproducing condition(s) included in the reproducing condition switching range, namely, the reproducing power P3 corresponding to the reproducing condition “the recording layer L3 and the speed V2” is set as the minimum power Pmin. Thus, while suppressing data damage, it is possible to further reduce the switching range of the reproducing power P, rather than setting the minimum reproducing power P1 in the power setting information T.

Further, in the above description, a case is described in which the reproducing power P is switched to the minimum power Pmin in accordance with the necessity of the switching of the reproducing condition that is detected after the start of the data reproducing operation. However, also at the time of the start of the data reproducing operation, the reproducing power P may be temporarily switched to the minimum power Pmin. Then, only after it has been confirmed that the reproducing power P is able to be appropriately switched, the reproducing power P may be switched to the optimum power Popt. Thus, even when the reproducing condition is erroneously set at the time of the start of the data reproducing operation, it is possible to avoid damage to the data recorded on the multi-layer disc D.

Furthermore, in the above description, a case is described in which the present invention is applied to the multi-layer disc D that is a blue-ray disc. However, the present invention can also be applied in a similar manner to another multi-layer recording medium in which data reproduction is recommended to be performed using a laser beam of the reproducing power P that differs depending on each of the recording layers L, and a relatively large gap in the reproducing power P is provided between the recording layers L.

The present application contains subject matter related to that disclosed in Japanese Priority Patent Application JP 2010-147634 filed in the Japan Patent Office on Jun. 29, 2010, the entire content of which is hereby incorporated by reference.

What is claimed is:

1. A playback device comprising:
a storage portion that stores power setting information that sets an optimum power corresponding to a reproducing condition that indicates a reproducing target recording layer;
a detection portion that detects a necessity of switching of the reproducing condition;
a reproducing condition switching portion that switches the reproducing condition in accordance with the necessity of switching of the reproducing condition;
a reading portion that reads out data recorded on a multi-layer recording medium and an address of the data;
a confirmation portion that confirms whether the read out address matches an address of reproducing target data;
a power switching portion that switches the reproducing power in response to the switching of the reproducing condition; and
a power switching portion that, when the necessity of switching of the reproducing condition is detected, switches the reproducing power to a minimum power which does not damage the data recorded on the multi-layer recording medium and with which the address of the reproducing target data can be read out, and when it is confirmed after the switching of the reproducing condition that the address read out with the minimum power matches the address of the reproducing target data, switches the reproducing power to the optimum power that corresponds to the reproducing condition after the switching, based on the power setting information.

2. The playback device according to claim 1,
wherein the power setting information sets the optimum power corresponding to the reproducing condition that indicates the reproducing target recording layer and a rotation speed of a reproducing target track.

3. The playback device according to claim 1 or 2,
wherein the minimum power is set as a minimum power among powers set as the power setting information.

4. The playback device according to claim 3,
wherein the minimum power is set as a minimum power among powers set in accordance with the reproducing condition included in a switching range of the reproducing condition.

5. The playback device according to any one of claims 1 to 4,
wherein the multi-layer recording medium has at least three recording layers, and it is recommended that the reproducing power is different between at least one layer and another layer adjacent to the one layer.

6. A playback method, comprising the steps of:
detecting a necessity of switching of a reproducing condition that indicates a reproducing target recording layer;
switching, when the necessity of the switching is detected, a reproducing power to a minimum power which does not damage data recorded on a multi-layer recording medium and with which an address of reproducing target data can be read out;
reading out the address of the reproducing target data with the minimum power, after switching the reproducing condition;
confirming whether the read out address matches the address of the reproducing target data;
switching, when it is confirmed that the addresses match with each other, based on power setting information that sets an optimum power that corresponds to the reproducing condition, the reproducing power to the optimum power that corresponds to the reproducing condition after the switching; and
reading out the reproducing target data with the optimum power.

7. The playback method according to claim 6,
wherein the reproducing condition indicates the reproducing target recording layer and a rotation speed of a reproducing target track.

8. The playback method according to claim 6 or 7, further comprising the step of:
confirming, after the necessity of the switching is detected, whether the optimum power corresponding to the reproducing condition before the switching is different from the optimum power corresponding to the reproducing condition after the switching, based on the power setting information,
wherein only when the optimum powers are different from each other, the subsequent processing that includes switching the reproducing power to the minimum power is performed.

9. A program that comprises instructions that command a computer to perform a playback method including the steps of:
detecting a necessity of switching of a reproducing condition that indicates a reproducing target recording layer;
switching, when the necessity of the switching is detected, a reproducing power to a minimum power which does not damage data recorded on a multi-layer recording medium and with which an address of reproducing target data can be read out;
reading out the address of the reproducing target data with the minimum power, after switching the reproducing condition;
confirming whether the read out address matches the address of the reproducing target data;
switching, when it is confirmed that the addresses match with each other, based on power setting information that sets an optimum power that corresponds to the reproducing condition, the reproducing power to the optimum power that corresponds to the reproducing condition after the switching; and
reading out the reproducing target data with the optimum power.
